(19) United States
(12) Patent Application Publication
(10) Pub. No.: US 2019/0270233 A1
(43) Pub. Date: Sep. 5, 2019

(54) Apparatus for Imparting Color to Food Material During the Decorating of Foods

(71) Applicants: Brenda Marie Grimes, Naples, FL (US); Charles Wilson Grimes, Naples, FL (US)

(72) Inventors: Brenda Marie Grimes, Naples, FL (US); Charles Wilson Grimes, Naples, FL (US)

(21) Appl. No.: 16/358,399

(22) Filed: Mar. 19, 2019

Related U.S. Application Data
(63) Continuation-in-part of application No. 15/804,801, filed on Nov. 6, 2017, now Pat. No. 10,315,348.
Application No. 15/804,801 is a continuation-in-part of application No. 13/852,507, filed on Mar. 28, 2013, now Pat. No. 9,808,977.
Application No. 13/852,507 is a division of application No. 13/366,863, filed on Feb. 6, 2012, now Pat. No. 8,790,110.
Application No. 13/366,863 is a continuation-in-part of application No. 13/184,021, filed on Jul. 15, 2011, now Pat. No. 8,794,959.

(51) Int. Cl. B29C 48/12; B29C 48/30; B29C 48/13; A21C 15/00; B29C 48/09

(52) U.S. Cl. CPC B29C 48/12; B29C 48/30; A23G 3/28; A21C 15/005; B29C 48/09; B29C 48/13

(57) ABSTRACT

An apparatus used for imparting color to food material during the decorating of foods. This apparatus can be used to impart color from solid, liquid or semi-liquid coloring compounds to a wide variety of food material such as frosting and icing.

### CROSS-REFERENCE TO RELATED APPLICATIONS

This application is a continuation-in-part of U.S. patent application Ser. No. 15/804,801, filed on Nov. 6, 2017 (pending), which is a continuation-in-part of U.S. patent application Ser. No. 13/852,507, filed on Mar. 28, 2013 (issued on Nov. 7, 2017 as U.S. Pat. No. 9,808,977), which is a divisional of U.S. patent application Ser. No. 13/366,863, filed on Feb. 6, 2012 (issued on Jul. 29, 2014 as U.S. Pat. No. 8,790,110), which is a continuation-in-part of U.S. patent application Ser. No. 13/184,021, filed on Jul. 15, 2011 (issued on Aug. 5, 2014 as U.S. Pat. No. 8,794,959). The entire disclosures of those applications are hereby incorporated herein by reference.

### BACKGROUND OF THE INVENTION

The apparatus of this invention “resembles” components of a commonly used, prior art “Disposable Decorating Bag” (“DDB”), such as those manufactured and sold by Wilton Brands, Inc., Hutzler Manufacturing Co., Inc. and Kitchen Krafts, Inc.

However, there are significant differences between the apparatus of this invention and the components of previous DDB apparatus, both in terms of construction and manner of operation.

The typical DDB apparatus is a multi-piece construction, including a bag, a non-disposable rigid decorating tip (sometimes also referred to as a “nozzle” or an “orifice”) with treatment means at the annular discharge end of the tip and a coupler and coupler collar. Typical DDB tips are made of metal or rigid white plastic and the coupler and coupler collar are made of rigid white plastic.

In order to use the DDB apparatus, a DDB bag is assembled with a desired decorating tip (i.e., with the desired opening size and treatment means at the annular end) using a coupler and coupler collar.

The ability to have different sized discharge openings with a DDB apparatus necessitates the user having a selection of different tips.

If, after initial use, the user decides a larger size opening is desired, the user must disassemble the DDB apparatus and reassemble the DDB apparatus with a new tip.

If the user wants to create an output with multiple colors, i.e., a stream of food material with sections having differing colors, the prior art teaches using a cumbersome apparatus such as the Wilton ColorSwirl™ 3 Color Coupler, 411-1992. The aforementioned Wilton device requires the use of multiple bags of colored frosting, brought together with a multi-channel coupler. This device, wherein the user is effectively expected to simultaneously handle multiple bags of colored frosting, is cumbersome and unwieldy. Notably, such prior art apparatus would not allow for the interchangeability of colors mid-output, as is possible with this invention, i.e., if the user wants to stop mid-output, and change the output colors, it is not possible with the prior art apparatus in the same manner as can be done with this invention.

Alternatively, it is known in the prior art that a user can “stripe” a bag with coloring gels on the inside wall of the bag, before insertion of the food material, in order to impart color to the food material upon extrusion. Such prior art “striping” methods also do not allow for interchangeability of colors mid-output, nor do they allow for refurbishment of the coloring agents, i.e., if the food coloration becomes too diluted, mid-output, as can be done with this invention.

Moreover, if the user wants to create an output with a three dimensional ribbon candy design, i.e., a stream of food material with channels having alternating stripes of color on the channel peaks and in the channel valleys, it is not possible with the prior art DDB apparatus, the aforementioned Wilton device or the aforementioned “striping” method.

The apparatus of this invention, in a first version, which is the preferred embodiment, is a nozzle for use with a funnel-shaped bag, having a first end for attaching to the bag, a second distal end for treating the food material as it is extruded from the nozzle and coloring agents mounted on the internal wall of the nozzle for applying color to the food material as it interacts with the coloring agents as it passes through the nozzle. The coloring agents are mounted on the internal wall of the nozzle during the manufacture of the nozzle in one embodiment, and in another embodiment covered with a protective covering. In a third alternative embodiment, provision is made for mounting of the coloring agents to the internal wall after manufacture of the nozzle and before use of the nozzle, either by depositing a liquid coloring agent in an undercut on the internal wall, by placing a solid coloring agent annular ring on a seat on the internal wall, or by placing solid coloring agent chips in pockets created on the internal wall by protrusions extending from the internal wall and cooperating retaining fingers.

In a second version, the apparatus of this invention is an interface device, adapted to be interposed between a conventional coupler and collar used in a DDB apparatus, wherein coloring agents are mounted on the internal wall of the interface device for applying color to the food material as it interacts with the coloring agents as it passes through the interface device. The coloring agents are mounted on the internal wall of the interface device during the manufacture of the interface device in one embodiment, and in another embodiment covered with a protective covering. In a third alternative embodiment, provision is made for mounting of the coloring agents to the internal wall after manufacture of the interface device and before use of the interface device, either by depositing a liquid coloring agent in an undercut on the internal wall, by placing a solid coloring agent annular ring on a seat on the internal wall, or by placing solid coloring agent chips in pockets created on the internal wall by protrusions extending from the internal wall and cooperating retaining fingers.

In a third version, the apparatus of the invention is an extension device, having a first end for attaching directly to a conventional coupler used in a DDB apparatus, i.e., without the need for a conventional collar, a second distal end for treating the food material as it is extruded from the extension device and coloring agents mounted on the internal wall of the extension device for applying color to the food material as it interacts with the coloring agents as it passes through the extension device. The coloring agents are mounted on the internal wall of the extension device during the manufacture of the extension device in one embodiment, and in another embodiment covered with a protective covering. In a third alternative embodiment, provision is made for mounting of the coloring agents to the internal wall after manufacture of the extension device and before use of the extension device, either by depositing a liquid coloring agent in an undercut on the internal wall, by placing a solid coloring agent annular ring on a seat on the internal wall, or by placing solid coloring agent chips in pockets created on the internal wall by protrusions extending from the internal wall and cooperating retaining fingers.

The second end of the nozzle or of the extension device, in select embodiments, has protrusions, serrations or ridges extending inwardly from the internal wall of the second end and running longitudinally or parallel to the axis, along all or a part of the length of the second end. The second end of the nozzle or extension device is made of a material so that it is capable of being cut at any point along its longitudinal dimension or along its axis to yield an exit opening or hole with a desired size or cross-sectional dimension. Regardless of the point of cut, i.e., regardless of the size of the hole or opening or the cross-sectional dimension, the inwardly extending serrations or ridges that remain insure that the material is “treated” as it is expelled from the bag through the second end to yield a three dimensional ribbon candy design, i.e., a stream of food material with channels having alternating stripes of color on the channel peaks and in the channel valleys.

In an alternative embodiment, the apparatus of this invention has sections of the second end with protrusions, serrations or ridges extending inwardly from the internal wall and running longitudinally or parallel to the axis and longitudinal sections without protrusions, serrations or ridges so that the second end can be cut at one of those areas and used as a piping bag.

Prior art patents have issued for a number of decorating, dispensing and icing bags, none of which disclose the unique features or advantages of the apparatus of this invention. Prior art patents noted but not believed to be relevant to the novelty or non-obviousness of the current invention include: Parker et al. U.S. Pat. No. 2,723,779; DeLorimiere U.S. Pat. No. 4,844,917; Tkac U.S. Pat. No. 4,961,517; Wallays U.S. Pat. No. 5,758,802; Wallays U.S. Pat. No. 5,931,346; Tedeschi, Jr. et al. U.S. Pat. No. 6,065,651; Gross et al. U.S. Pat. No. 6,273,307 B1; Lunghetti U.S. Pat. No. 6,386,395 B1; Franczyk U.S. Pat. No. 7,021,505 B2; Folkmar PCT No. WO 2004/049816 A1; Ejeblad PCT No. WO 2005/115162 A1; and Ejeblad PCT No. WO 2007/090588 A1.

### SUMMARY OF THE INVENTION

The apparatus of this invention in a first preferred version is a nozzle for use with a funnel-shaped bag, having a first end for attaching to the bag, a second distal end for treating the food material as it is extruded from the nozzle and coloring agents mounted on the internal wall of the nozzle for applying color to the food material as it interacts with the coloring agents as it passes through the nozzle. The coloring agents are either mounted on the internal wall of the nozzle during the manufacture of the nozzle, with or without a cover, or mounted on the internal wall after manufacture of the nozzle and before use of the nozzle, either by depositing a liquid coloring agent in an undercut on the internal wall, by placing a solid coloring agent annular ring on a seat on the internal wall, or by placing solid coloring agent chips in pockets created on the internal wall by protrusions and cooperating retaining fingers.

In a second version, the apparatus of this invention is an interface device provided with first and second ends so that it can be interposed between a conventional coupler and conventional collar, and with coloring agents mounted on the internal wall of the interface device, such that the benefits and features of this invention are achieved by the coloring agents mounted on the internal wall of the interface device albeit at a slightly higher price and without the convenience of the treatment of the food material as is possible with the second end of the nozzle design.

In a third version, the apparatus of this invention is an extension device provided with one end for attaching to a conventional coupler extending in a conventional manner out from a pastry bag, a second end for treating the food material in the same manner as the second end of the nozzle of this invention and coloring agents mounted on the internal wall of the interface device.

The apparatus of this invention can employ various output treatment designs for piping, decorating, filling, assembling and dispensing the food material in connection with any number of other cooking and baking activities without departing from the scope of this invention, e.g., cakes and cupcakes, stuffed shells, manicotti, cannoli's, deviled eggs, stuffed mushrooms, twice baked potatoes, cookies, canapés, pastry cups, meringue, etc.

The nozzle and extension devices of the first and third versions of the apparatus of this invention come in a variety of sizes, with “larger” apparatus having comparatively larger second ends and resultant outputs.

The apparatus can in select embodiments be completely disposable once use of it is complete.

The apparatus of this invention, i.e., in embodiments where the coloring agents are mounted in the nozzle, interface device or extension device during manufacture, can be packaged and sold like reusable, re-sealable zipper storage bags, such as the ZipLock® bags originally developed by Dow Chemical Company and now produced by S. C. Johnson & Son or Glad® bags produced by The Glad Products Company.

In select alternative embodiments of the apparatus of this invention, i.e., where the coloring agents are not mounted during manufacture in the nozzle, in the interface device or in the extension device, but rather, are mounted therein after manufacture and before use, the apparatus can be sold as re-usable items and the coloring agents can be sold separately in liquid form, in solid annual ring form or solid chip form.

As yet another alternative, a “starter box” of the apparatus of this invention may include a nozzle, interface device or extension device and an introductory selection of coloring agents, which will enable the user to use the apparatus in the box upon purchase and subsequently acquire additional/other coloring agents (e.g., for different holidays, etc.).

An object of the disclosed invention is to provide an apparatus for imparting color to a food material as it is extruded out of a pastry bag and onto food items.

A further object of the disclosed invention is to provide an apparatus for imparting color to a food material as it is extruded out of a pastry bag and onto food items, and to provide for the changing of the color mid-output.

A further object of the disclosed invention is to provide an apparatus for imparting color to a food material as it is extruded out of a pastry bag and onto food items, and to provide for refurbishment of the color mid-output.

A further object of the disclosed invention is to provide an apparatus that can enable the imparting of two or more colors to a food material as it is extruded out of a pastry bag and onto food items.

A further object of the disclosed invention is to provide an apparatus that can enable the imparting of two or more colors to a food material as it is extruded out of a pastry bag, and to provide for changing of one or more of the colors mid-output.

A further object of the disclosed invention is to provide an apparatus that can enable the imparting of two or more colors to a food material as it is extruded out of a pastry bag, and to provide for refurbishment of one or more of the colors mid-output.

A further object of the disclosed invention is to provide nozzles of the first version or extension devices of the third version with second ends which can be cut to a desired hole or opening size, while still retaining the color imparting and treatment capacity of the nozzle or extension device.

A still further object of this invention is to provide a nozzle of the first version or an extension device of the third version with a second end which is conical shaped and which has protrusions, serrations or ridges extending inwardly from the inside wall and running longitudinally or parallel to the conical axis, along the length of the second end, such that regardless of where the second end is cut and regardless of the resultant size of the hole or opening or cross-sectional dimension, the inwardly extending protrusions, serrations or ridges that remain insure that the food material that has been exposed to coloring agents that were mounted on the inside wall of the nozzle or extension device is “treated” as it is expelled from the bag through the second end, more particularly, the protrusions, serrations or ridges cut into the food material, causing the food material to split into alternating stripes of food material that: (a) has been in contact with the coloring agents on the inside wall of the nozzle or extension device and displays the effects of the coloring agents on the food material as it is expelled out through the second end; and (b) has not been in contact with the coloring agents on the inside wall of the nozzle or extension device and passes out through the second end without displaying any effect from the coloring agents.

A still further object of this invention is to provide a nozzle of the first version or an extension device of the third version with a second end which is conical shaped and which has protrusions, serrations or ridges extending inwardly from the inside wall and running longitudinally or parallel to the conical axis, along the length of the second end, such that the user can create an output with a three dimensional ribbon candy design, i.e., a stream of food material with channels having alternating stripes of color on the channel peaks and channel valleys, both initially when the second end of the nozzle or extension device is cut for a small size output, and subsequently when, without the muss and fuss of disassembly, the second end of the nozzle or extension device is simply cut again in order to achieve a larger size output.

### BRIEF DESCRIPTION OF THE FIGURES

FIG. 1 depicts a side view of a preferred embodiment of a first version of the apparatus disclosed herein, namely, of a nozzle that has been attached to a pastry bag, in this case, during manufacture.

FIG. 2 depicts a sectional view of the apparatus in FIG. 1. The nozzle 10 is shown before the coloring agents have been mounted on the internal wall of the nozzle, for example, as shown in FIGS. 11, 12 and 13.

FIG. 3 depicts a top view of the apparatus in FIG. 1.

FIG. 4 depicts a bottom view of the apparatus in FIG. 1.

FIG. 5 depicts a side view of a second alternative of the preferred embodiment of first version of the apparatus disclosed herein, namely, of a nozzle that has been attached to a pastry bag, in this case, during manufacture.

FIG. 6 depicts a sectional view of the apparatus in FIG. 5. The nozzle 110 is shown before the coloring agents have been mounted on the internal wall of the nozzle, for example, as shown in FIGS. 11, 12 and 13.

FIG. 7 depicts a top view of the apparatus in FIG. 5.

FIG. 8 depicts a bottom view of the apparatus in FIG. 5.

FIG. 9 depicts the cross-sectional dimension of the orifice of a still further alternative embodiment of the apparatus disclosed herein.

FIGS. 10 and 10A depict two further alternative embodiments of the apparatus disclosed herein, wherein each orifice has cuttable sections for affecting “treated” flow of the food material alternating between sections for affecting “non-treated” or “piping” flow of the food, the former sized for affecting increasingly larger cross-sectional dispensing holes, and the latter sized for affecting constant cross-sectional dispensing holes.

FIG. 11 displays the addition of color reservoirs to the apparatus of this invention, that are mounted during manufacture on the internal wall of the nozzle or orifice, connected to piping that extends down into the nozzle or orifice.

FIG. 12 displays the addition of color deposits to the apparatus of this invention during manufacture, that are covered with removable sealing strips.

FIG. 13 displays the addition of a color agent to the apparatus of this invention, that is mounted during manufacture on the internal wall of the nozzle or orifice, that can be one piece (not shown) or multiple abutting pieces (as shown).

FIG. 14 is a perspective view of the apparatus of this invention shown with food material being expelled from it with a three dimensional ribbon candy appearance, i.e., a stream of food material with channels displaying a different color on the channel peaks than the color displayed in the channel valleys, produced by exposing the food material to coloring agents that were either: (a) mounted on the internal wall of the nozzle during manufacture (as seen in FIG. 11 or 12), or (b) manually mounted on the internal wall of the nozzle before insertion of the food material into the bag (as seen in FIG. 23-25, 27 or 28B) and that was “treated” as it was expelled from the bag through the orifice by the protrusions, serrations or ridges in the orifice, namely, food material that has channel peaks and channel valleys cut into it by the protrusions, serrations or ridges, and where: (a) first portions of food material that were in contact with the coloring agents were expelled out on the peaks of the channel displaying the effects of the coloring agents; and (b) second portions of food material that were not in contact with the coloring agents were expelled out in the valleys of the channel without displaying the effects of the coloring agents.

FIG. 15 is close-up perspective view of the apparatus of this invention showing the “treatment” of the food material within the orifice that yields the unique three dimensional ribbon candy appearance in the expelled food material.

FIG. 16 is close-up perspective view of the apparatus of this invention showing an orifice that has been cut to a very large opening size (as contrasted, for example, with the size of the opening cut shown in FIG. 15), and which nevertheless achieves the “treatment” of the food material within the orifice that yields the unique three dimensional ribbon candy appearance in the expelled food material.

FIG. 17 is a top plan view of a stream of food material expelled from the apparatus of this invention with a three dimensional ribbon candy appearance.

FIGS. 18-22 are prospective views of streams of food material produced with the apparatus of this invention with a three dimensional ribbon candy appearance and, through the manipulation of the apparatus during expulsion, having different and unique decorating designs.

FIG. 18 shows a “braid” design with a three dimensional ribbon candy appearance.

FIG. 19 shows a horizontally undulating “scallop” design with a three dimensional ribbon candy appearance (FIG. 15 shows a vertically undulating “scallop” design with a three dimensional ribbon candy appearance).

FIG. 20 shows a “swirl” stacked vertically with a three dimensional ribbon candy appearance.

FIG. 21 shows a “swirl” laid horizontally with a three dimensional ribbon candy appearance.

FIG. 22 shows a “star” design with a three dimensional ribbon candy appearance.

FIG. 23 shows a nozzle having an annular undercut which extends around the internal wall and defines a reservoir for receiving liquid coloring agents.

FIG. 24 shows a nozzle having multiple undercuts spaced around the internal wall and defining multiple reservoirs for receiving liquid coloring agents.

FIG. 25 shows a nozzle having an annular shelf defining a seat for receiving solid coloring agents.

FIG. 26 shows an annular shaped solid coloring agent which can be seated on the seat of the nozzle of FIG. 25.

FIG. 27 shows a nozzle having multiple protrusions extending from the internal wall which act as seats for receiving solid coloring agent chips, and retaining fingers for holding the chips on the seats,

FIGS. 28A, B and C respectively show a conventional coupler loaded within a pastry bag, a nozzle of the disclosed invention with an undercut as shown in FIG. 23, and a conventional collar, before the liquid coloring agent is loaded into the reservoir of the nozzle and the nozzle is clamped onto the pastry bag through the mating interaction of the coupler and collar.

FIGS. 29A and B respectively show a conventional coupler loaded within a pastry bag and an interface device of the invention, having a shelf analogous to the shelf as shown in FIG. 25, before a desired conventional treatment nozzle and collar (not shown) are attached to the interface device.

FIGS. 30A and B respectively show a conventional coupler loaded within a pastry bag and an extension device of the invention having a shelf analogous to the shelf as shown in FIG. 25.

### DETAILED DESCRIPTION OF THE INVENTION

The apparatus of this invention can be used with a variety of viscous foodstuffs, including icing to decorate a variety of foods, such as cakes, cookies, canapés, pastry cups, meringue, etc.

In a first version, the apparatus is a discharge nozzle or orifice for attachment to the end of a pastry bag for applying color to and “treating” material being expelled from the bag through the nozzle or orifice. This nozzle or orifice is shown, for example. in FIGS. 2, 6, 11, 12, 13, 23, 24, 25, 27 and 28B,

To create an aesthetic design in the dispensed material, the apparatus has coloring agents mounted on its internal wall that color the material and jagged inwardly facing edges or protrusions, ridges or serrations extending inwardly from its internal wall that “treat” the material as it passes through the nozzle or orifice.

The coloring agents can be mounted in the nozzle during manufacture, or mounted therein after manufacture and before use, and the coloring agents can be sold separately in liquid form, in solid annual ring form or solid chip form.

While the nozzle or orifice is capable of coloring and treating, i.e., “decorating,” the material as it is discharged from the bag, the nozzle or orifice can be cut at a first location to achieve an output of a first desired size without deleteriously impacting the treatment, and thereafter cut again at another desired point, to achieve a second desired size, also without deleteriously impacting the treatment.

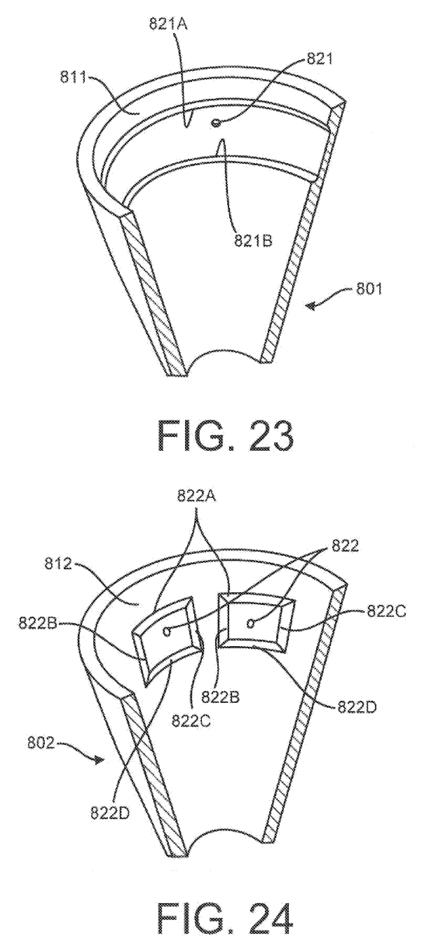

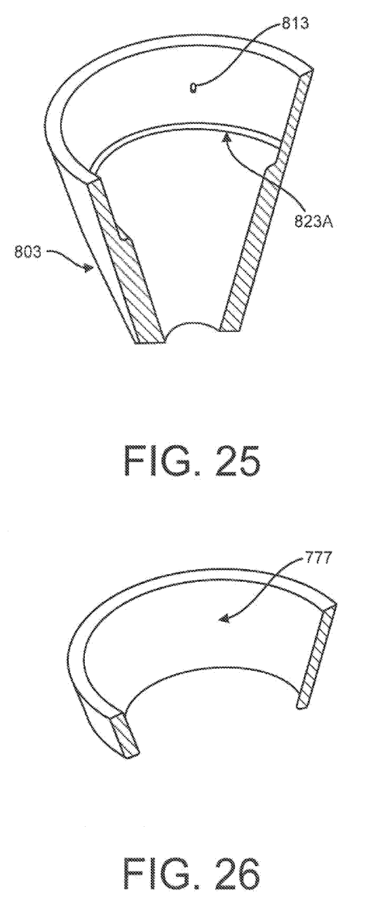

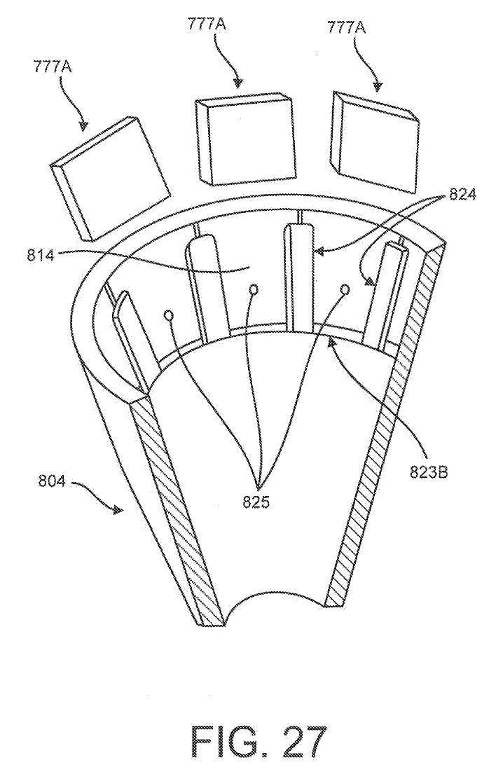

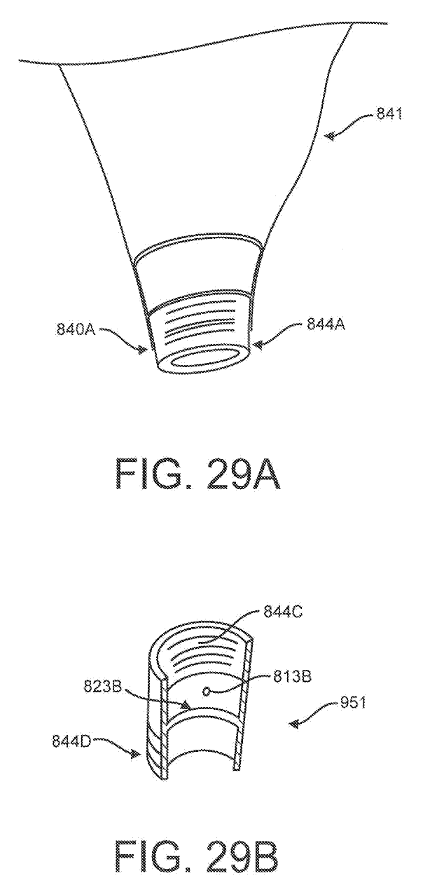

In a second version, the apparatus is an interface device for interposition between a conventional coupler and conventional mating collar, for applying color to material being expelled from the bag through the coupler and interposed interface device and out through an attached nozzle. This interface device is shown, for example. in FIG. 29B. The construction of the internal wall of the interface device can be the same as the construction of the internal wall of the nozzle of the first version of the invention, albeit eliminating the treatment means at the second end of the nozzle. As shown in FIG. 29B, the interface device has the same construction as the device of FIG. 25, namely, an internal shelf. Without departing from the scope of the second version of the invention, the internal wall of the interface device can be constructed with the coloring agents mounted thereon during manufacture (as shown in FIG. 11), with a cover over the coloring agents (as shown in FIG. 12), with an undercut defining one or more reservoirs (as shown in FIGS. 23 and 24), and/or with cooperating protrusions and fingers (as shown in FIG. 27).

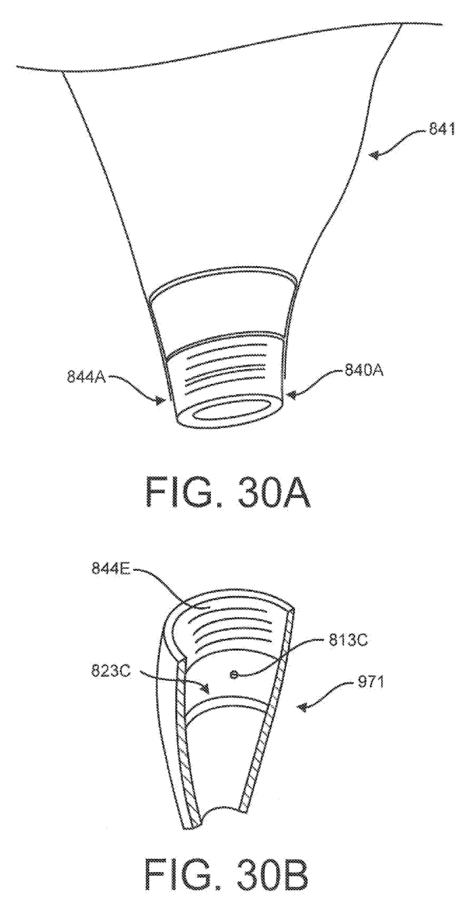

In a third version, the apparatus is an extension device for attachment directly to a conventional coupler, for applying color to and “treating” material being expelled from the bag through the coupler and the attached extension device. This extension device is shown, for example. in FIG. 30B. The construction of the internal wall of the extension device can be the same as the construction of the internal wall of the nozzle of the first version of the invention, including the treatment means at the second end of the nozzle. As shown in FIG. 30B, the interface device has the same construction as the device of FIG. 25, namely, an internal shelf. Without departing from the scope of the third version of the invention, the internal wall of the extension device can be constructed with the coloring agents mounted thereon during manufacture (as shown in FIG. 11), with a cover over the coloring agents (as shown in FIG. 12), with an undercut defining one or more reservoirs (as shown in FIGS. 23 and 24), and/or with cooperating protrusions and fingers (as shown in FIG. 27).

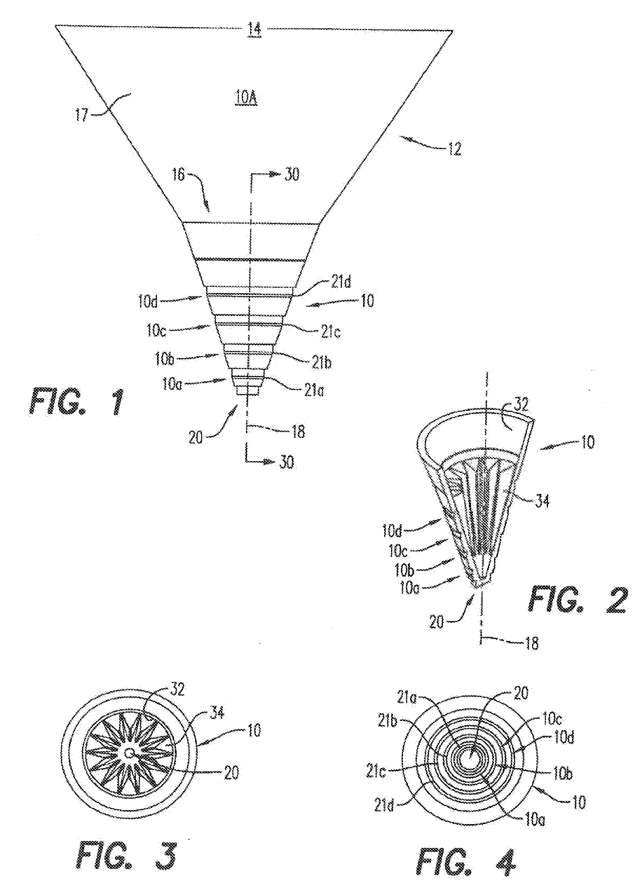

Referring now to the figures, FIGS. 1 through 4 show a first version of the apparatus in accordance with this invention, albeit before the coloring agents have been mounted on the internal wall of the nozzle.

In FIG. 1, a side view of the nozzle or discharge orifice 10 is shown, with an integral bag 12. The bag 12 is funnel shaped and the bag 12 is either attached to the nozzle 10 during manufacture, as a simultaneously created one piece construction, or the bag 12 is attached to the nozzle 10 in a secondary operation, e.g., by making the nozzle first, for example, by injection molding, and then by dip molding the bag over it, or by welding, gluing or connecting the nozzle and bag together by other means available and known in the art, including by using a disposable connection mechanism. The bag 12 has a first end 14 that is at the “top” or wider end of the funnel shape that is “open” and through which the food material 10A can be inserted into the bag 12, a second end 16 that is at the “bottom” or narrow end of the funnel shape that is “closed” as a result of the attachment of the nozzle 10, and a soft side wall 17 that allows the user to squeeze the bag 12 and cause food material 10A in the bag 12 to be expelled out of the bag 12 through the nozzle 10. The nozzle 10 is malleable and conical shaped and has a conical axis 18 and a discharge opening or hole 20. The sections 10a, 10b, 10c and 10d of the nozzle 10 are increasingly larger in cross-section and each respectively has a “cut line” 21a, 21b, 21c and 21d at which the nozzle 10 can be cut prior to or during use to achieve different the desired different opening or hole 20.

FIG. 2 shows a cut away view of the nozzle 10 of FIG. 1, taken along the line 30-30 in FIG. 1. The elements of the nozzle 10 seen in FIG. 1 that are still visible in FIG. 2 are similarly numbered. FIG. 2 additionally shows the internal wall 32 of the nozzle 10 and the protrusion, serrations or ridges 34 that extend inwardly from said internal wall 32 and run longitudinally along the length of the nozzle 10, parallel to the conical axis 18. Thus it can be seen that regardless of whether the nozzle 10 is cut at “cut line” 21a, i.e., at a point close to the hole 20 and before the protrusions 34 begin, or at any of the other “cut lines” 21b, 21c or 21d, which would cause a portion of the protrusions 34 also to be cut, lengths of the protrusions 34 remain within the nozzle 10 that “treat” the food material 10A as it passes from the bag 12 through the nozzle 10 and out the hole 20.

FIG. 3 is a top view of the nozzle 10 (as would be seen were one to look at the nozzle down into and through the bag 12). The protrusions 34 extending inwardly from the internal wall 32 create a star-shape that is imparted to the food material 10A as it passes through the nozzle 10 and is “treated” thereby.

FIG. 4 is a bottom view of the nozzle 10 before any cut has been made, showing all of the sections 10a, 10b, 10c and 10d and the cut lines 21a, 21b, 21c and 21d.

Either before or after the food material 10A is introduced into the bag 12, the user cuts the nozzle 10 at a desired cut line 21a, 21b, 21c or 21d to achieve a desired opening or hole 20 and controlled dispensation of the food material 10A out through the nozzle 10. If the user initially cuts at cut line 21b, sufficient length of protrusions 34 remain to “treat” the food material 10A as it passes through the nozzle 10. If a lump clogs the nozzle 10, the nozzle is malleable enough to allow the lump to “pass.” The manner in which the nozzle 10 will “pass” the lump depends upon which of the two embodiments of the invention is being employed. If the nozzle 10 is elastic, it will expand upon the user's application of pressure to the bag 12 and the lump will be expelled and the nozzle 10 will return to its normal size and shape. Alternatively, if the nozzle 10 is plastic, it will allow the user to apply pressure to the lump upstream of the opening 20 by squeezing the nozzle, to thereby break up the lump. The broken up lump will then be able to pass through the opening 20 and the nozzle will return to its normal size and shape.

During use, if the user would like to increase the size of the opening or hole 20, the user can elect to make a further cut in the nozzle 10. For example, if the user made the first cut at line 21b as described above, the user can elect to make a further or second cut in the nozzle 10 at cut line 21c or at cut line 21d to achieve a desired larger opening or hole 20 and controlled dispensation of a greater amount of the food material 10A out through the nozzle 10. If the user cuts at cut line 21c or cut line 21d, sufficient length of protrusions 34 nevertheless still remains to “treat” the food material 10A as it passes through the nozzle 10. If a lump clogs the nozzle 10, the nozzle is still malleable enough to allow the lump to “pass.” The manner in which the nozzle 10 will “pass” the lump still depends upon which of the two embodiments of the invention is being employed. If the nozzle 10 is elastic, it will still expand upon the user's application of pressure to the bag 12 and the lump will be expelled and the nozzle 10 will return to its normal size and shape. Alternatively, if the nozzle 10 is plastic, it will still allow the user to apply pressure to the lump upstream of the opening 20 by squeezing the nozzle, to thereby break up the lump. The broken up lump will then be able to pass through the opening 20 and the nozzle will return to its normal size and shape.

If the user needs to, additional material can be added to the bag 12. Once the user is finished, the entire apparatus can be completely disposed of.

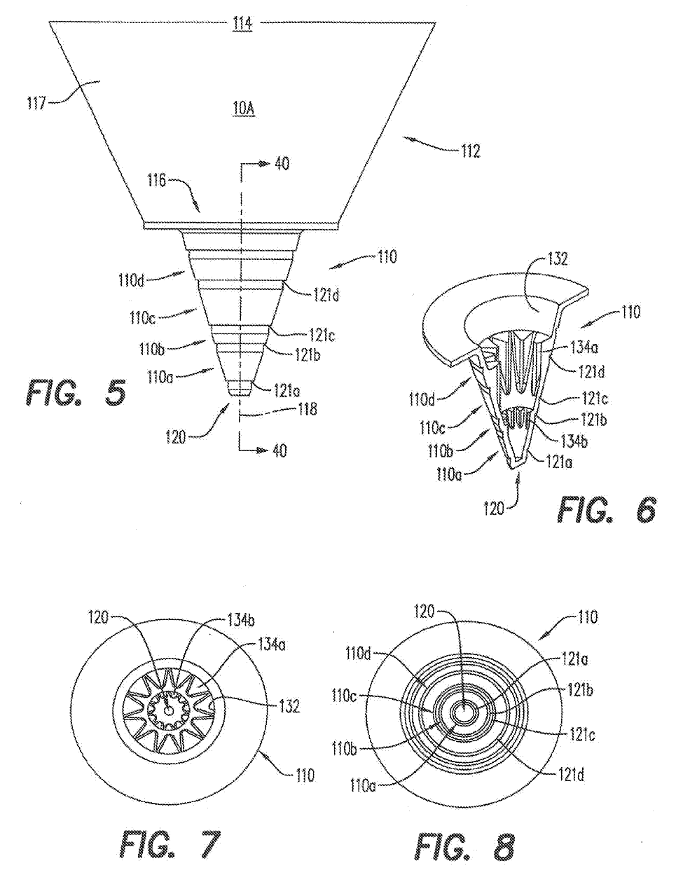

FIGS. 1-4 show the apparatus according to this invention where the protrusions 34 run the length of the nozzle 10. FIGS. 5-8 show an alternative embodiment where the protrusions 36 are sections strategically placed between the cut lines.

In FIG. 5, a side view of an alternative nozzle or discharge orifice 110 is shown, with an integral bag 112. The bag 112 is funnel shaped and the bag 112 is either attached to the nozzle 110 during manufacture, as a simultaneously created one piece construction, or the bag 112 is attached to the nozzle 110 in a secondary operation, e.g., by making the nozzle first, for example, by injection molding, and then by dip molding the bag over it, or by welding, gluing or connecting the nozzle and bag together by other means available and known in the art, including by using a disposable connection mechanism. The bag 112 has a first end 114 that is at the “top” or wider end of the funnel shape that is “open” and through which the food material 10A can be inserted into the bag 112, a second end 116 that is at the “bottom” or narrow end of the funnel shape that is “closed” as a result of the attachment of the nozzle 110, and a soft side wall 117 that allows the user to squeeze the bag 112 and cause food material 10A in the bag 112 to be expelled out of the bag 112 through the nozzle 110. The nozzle 110 is malleable and conical shaped and has a conical axis 118 and a discharge opening or hole 120. The sections 110a, 110b, 110c and 110d of the nozzle 110 are increasingly larger in cross-section and each respectively has a “cut line” 121a, 121b, 121c and 121d at which the nozzle 110 can be cut prior to or during use to achieve different the desired different opening or hole 120.

The difference between the nozzle 10 and nozzle 110 is that, as best seen in FIG. 6 (a cut away view of the nozzle 110 of FIG. 5, taken along the line 40-40 in FIG. 5), depending upon where the cut is made in the nozzle 110, the opening 120 will end up being either an annular opening without protrusions 110 (i.e., if the cut is made at 121a or 121c) or an opening with the inwardly extending protrusions 134a (if the cut is made at 121d) or protrusions 134b (if the cut is made at 121b). The elements of the nozzle 110 seen in FIG. 5 that are still visible in FIG. 6 are similarly numbered. FIG. 6 additionally shows the internal wall 132 of the nozzle 110 and the protrusion, serrations or ridges 134a and 134b that extend inwardly from the internal wall 132 and run longitudinally for discrete sections along the length of the nozzle 110, parallel to the conical axis 118.

FIG. 7 is a top view of the nozzle 110 (as would be seen were one to look at the nozzle 110 down into and through the bag 112). The protrusions 134a and 134b extending inwardly from the internal wall 132 create two different star-shapes, one of which might be imparted to the food material 10A as it passes through the nozzle 110, depending upon the cut that is made in the nozzle 110, as described herein.

FIG. 8 is a bottom view of the nozzle 110 before any cut has been made, showing all of the sections 110a, 110b, 110c and 110d and the cut lines 121a, 121b, 121c and 121d.

As with the preferred embodiment, either before or after the food material 10A is introduced into the bag 112, the user cuts the nozzle 110 at a desired cut line 121a, 121b, 121c or 121d to achieve a desired opening or hole 120 and controlled dispensation of the food material 10A out through the nozzle 110. If the user initially cuts at cut line 121a or 121c, the food material 10A will pass through the resultant annular opening without any sort of design “treatment.” If the user cuts the nozzle 110 at 121b or 121d, the protrusions 134b and 134 a, respectively, will “treat” the food material 10A as it passes through the nozzle 110.

Regardless of where the cut in the nozzle 110 is made, if a lump clogs the nozzle 110, the nozzle is malleable enough to allow the lump to “pass.” The manner in which the nozzle 110 will “pass” once again depends upon which of the two embodiments of the invention is being employed. If the nozzle 110 is elastic, it will expand upon the user's application of pressure to the bag 112 and the lump will be expelled and the nozzle 110 will return to its normal size and shape. Alternatively, if the nozzle 110 is plastic, it will allow the user to apply pressure to the lump upstream of the opening 120 by squeezing the nozzle, to thereby break up the lump. The broken up lump will then be able to pass through the opening 120 and the nozzle will return to its normal size and shape.

During use of the alternative embodiment of FIGS. 5-8, if the user cuts the nozzle 110 at cut line 121b, the food material 10A will be “treated” by protrusions 134b as it is passed through the nozzle 110 and out of the opening 120. If the user would like to switch and have the food material 10A dispensed without treatment, e.g., for “piping,” the user can elect to make a further or second cut at cut line 121c. Thereafter, the user can elect to make a still further or third cut in the nozzle 110 at cut line 121d so that the food material 10A will be “treated” by protrusions 134a as it is passed through the nozzle 110 and out of the opening or hole 120.

Regardless of where the user cuts the nozzle 110, if a lump clogs the nozzle 110, the nozzle 110 is still malleable enough to allow the lump to “pass.” The manner in which the nozzle 110 will “pass” the lump still depends upon which of the two embodiments of the invention is being employed. If the nozzle 110 is elastic, it will still expand upon the user's application of pressure to the bag 112 and the lump will be expelled and the nozzle 110 will return to its normal size and shape. Alternatively, if the nozzle 110 is plastic, it will still allow the user to apply pressure to the lump upstream of the opening 120 by squeezing the nozzle 110, to thereby break up the lump. The broken up lump will then be able to pass through the opening 20 and the nozzle 110 will return to its normal size and shape.

The user can refill the bag 112 of the apparatus of alternate embodiment as needed and, once the user is finished, the entire apparatus can be completely disposed of.

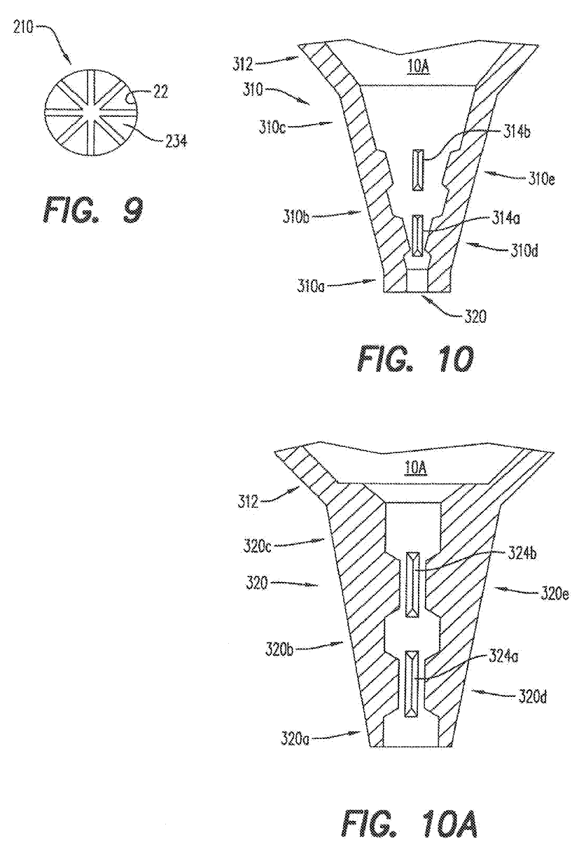

FIG. 9 shows a bottom view of a nozzle 210 according to this invention with a design for protrusions 234 extending inwardly from the inside wall 232 that has been found to be preferred.

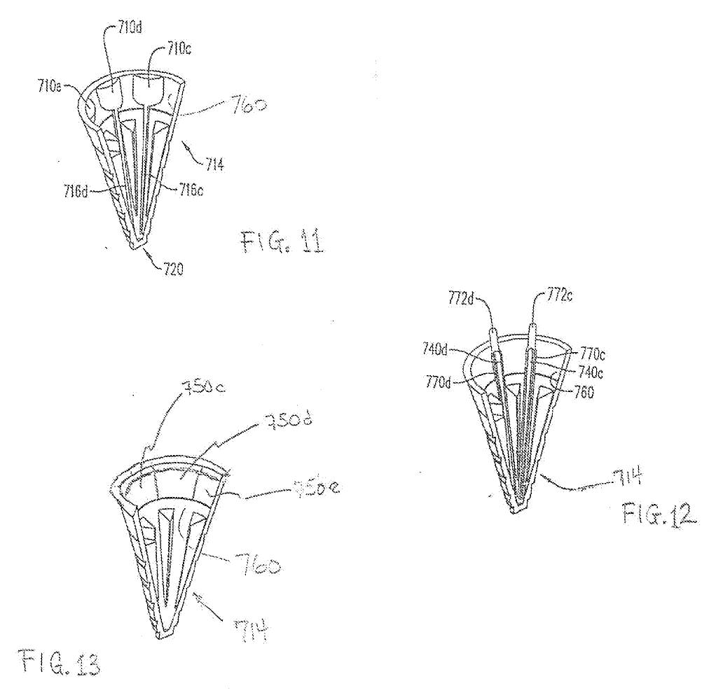

FIG. 10 shows a nozzle 310 attached to bag 312, for dispensing food material 10A, which nozzle 310 is similar to the nozzle 110 shown in FIGS. 5-8, in that it has alternating internal profiles. The internal profiles of sections 310a, 310b and 310c are circular and the internal profiles of sections 310d and 310e are star shaped as a result of the internal protrusions 314a and 314b. Where the cut is made in nozzle 310 will alter the manner in which food material 10A is dispensed out of hole 320.

FIG. 10A shows a nozzle 320 attached to the bag 322, for dispensing food material 10A, which nozzle is similar to the nozzle 310 shown in FIG. 10 and the nozzle 110 shown in FIGS. 5-8, in that it has alternating internal profiles. The internal profiles of sections 320a, 320b and 320c are all circular and they all are of the same cross-sectional dimension. The internal profiles 320d and 320e have identically sized internal protrusions 324a and 324b and they are of the same cross-sectional dimension. Accordingly, during use, the user can select to make a cut at 320a for “un-treated” dispensing of the food material, and then to make a cut at 320d for effecting “treated” dispensing of the food material, and then another cut at 320b for the same “un-treated” dispensing as effected by section 320a, and then a cut at 320e for the same “treated” dispensing as affected by section 320d, and finally a cut at 320c for effecting the same “un-treated” dispensing as effected by sections 310a and 310b.

Once the cut is made in a nozzle constructed in accordance with this invention, it remains possible to make a new cut, to enlarge the opening, without having to remove the food material from the bag and without having to take any other intermediary steps.

The design of the unique nozzle according to this invention allows the food material to be dispensed through the nozzle in a uniform, controlled and yet easy and effortless manner. Problems of lumps and clogs no longer cause the dispensation to have to be stopped to take time consuming remedial measures.

The dimensioning of the tip has been found to be critical. Slitted nozzle end designs of prior art devices may “give enough” to allow food to pass, but they are not capable of both widening out to enable desired passage of lumps and subsequently providing continued “treatment.” Moreover, slitted ends can result in ribbons of food coming out the side of the nozzle hole when a lump is encountered. Further, slitted ends preclude the selection of a cut area anywhere along the longitudinal length of the conical nozzle. The longitudinally extending internal protrusions of this invention overcome such deficiencies.

The material used to manufacture the nozzle is critical. It cannot be rigid as with prior art devices as it will not allow lumps or clogs to be passed. At the same time, it must not be too elastic so that the nozzle has no “integrity” and thus no control of the flow of the food material. A suitable elastic material in the embodiment where the nozzle is expected to flex and open would be either a thermoset elastomer, such as latex rubber or silicone rubber, or a thermoplastic elastomer, such as polyurethane. A suitable flexible but non-elastic material would be a thermoplastic such as polyethylene. These materials enable the user to clear clogs without taking the food out of the bag, either by expanding to allow the clog to pass (preferred), or by allowing the user to crush and break up the clog (alternative).

The nozzle should be made of a material of between 27 A and 60 A durometers, with 60A being the preferred embodiment.

In the preferred embodiment, the widest cut of the nozzle should yield a star shaped opening of up to 0.8 inches in inside diameter.

The cut lines can be notches as shown and can include colors and a color-coded guide to help the user understand where to cut.

Referring to FIG. 11, in order to introduce color into the food material as it is expelled, pre-positioned quantities of coloring agents can be manufactured into one or more reservoirs 710c, 710d and 710e on the internal wall 760 of the nozzle 714 as shown in FIG. 11, such that pressure (as well as heat and moisture) from the food material (not shown) can activate the reservoirs 710 c-e and cause the simultaneous activation of the coloring agents. In an alternative embodiment, the coloring agents in reservoirs 710c, 710d and 710e are liquid and tubes or piping 716c, 716d and 716e can lead from the reservoirs 710c, 710d and 710e alongside the edge of the nozzle 714 to a closed end at the area of the end of the nozzle 720. Cutting the nozzle can simultaneously result in cutting of the color tubes or piping 716c, 716d and 716e.

Referring to FIG. 12, an alternate embodiment for introducing color into the food material as it is expelled is disclosed. Pre-positioned quantities of coloring agents can be placed in longitudinally extending deposits 740c and 740d on the internal surface 760 of the nozzle 714 as shown in FIG. 12. Prior to use, the integrity and viability of the color deposits is ensured by sealing strips 770c and 770d that overlay and seal the color deposits. Prior to depositing the food material in the bag (not shown) to which the nozzle 714 is attached, in order to prepare the color deposits for “activation” by the passage of food material thereby, such sealing strips 770c and 770d are removed by pulling on tabs 772c and 772d, respectively.

Referring to FIG. 13, an alternate embodiment for introducing color into the food material as it is expelled is disclosed. Pre-positioned quantities of solid material coloring agents 750c, 750d and 750e can be mounted on or applied to (i.e., sprayed on and allowed to dry) the internal wall 760 of the nozzle 714, such that heat and moisture from the food material (not shown) can cause activation of the coloring agents 750c-e. The solid material coloring agents can be mounted or applied as one piece (not shown) or multiple pieces (as shown).

Alternatively, referring to FIGS. 23 and 24, coloring agents such as food coloring gels can be inserted into the nozzle 801 or 802 and applied to the internal surface or wall 811 or 812 of the nozzle 801 or 802 in the one undercut 821 or in the multiple undercuts 822 just prior to the time when the food material is inserted into the bag. For example, using a stick or any other transfer device, color gel can be taken from a gel pot and applied to the inside wall 811 or 812 of the nozzle 801 or 802 in the undercuts 821 or 822. As another example, color gel can be squeezed out of a dispensing tube into the undercuts 821 or 822 in the inside wall 811 or 812 of the nozzle 801 or 802. Alternatively, one color gel is applied to one area of the undercut 821 of nozzle 801 or to one of the undercuts 822 in nozzle 802 and another color gel is applied to another area of the undercut 821 of nozzle 801 or to another of the undercuts 822 in nozzle 802 to achieve a multi-colored three dimensional ribbon candy appearance.

The liquid coloring agent will be held in the undercut 821 or within the multiple undercuts 822 by the side walls 821A and B or side walls 822 A, B, C and D. The side walls act to prevent the liquid coloring agent from being spread out across the face of the internal wall by the pressure of the food material passing through the nozzle. The side walls 821B and 822D also assist in keeping the flowing food material from pushing the liquid coloring agent downstream and out of the nozzle. The liquid coloring agents in one embodiment are selected to have a viscosity higher than that of the flowing food material to enable the liquid coloring agents to better withstand the force of the flowing food material.

Alternatively, referring to FIGS. 25, 26 and 27, coloring agents such as pieces of solid food coloring 777 or 777A can be inserted into the nozzle 803 or 804 and seated on a shelf 823A or protrusions 823B extending from an internal surface or wall 813 or 814, respectively, just prior to the time when the food material is inserted into the bag. The solid color agent can be a one-piece annular ring 777 or it can be one or more chips 777A. The ring 777 can be one color or it can be made up of multiple colors. The chips 777A can be the same color or more than one color. Retaining fingers 824 can be provided which, together with the protrusions 823B, define pockets 825 in which the chips 777A are held.

The shelf 823A and the protrusions 823B and fingers 824, respectively, assist in keeping the flowing food material from moving the solid coloring agent ring off of the seat or the solid coloring agent chips out of the pockets and downstream and out of the nozzle.

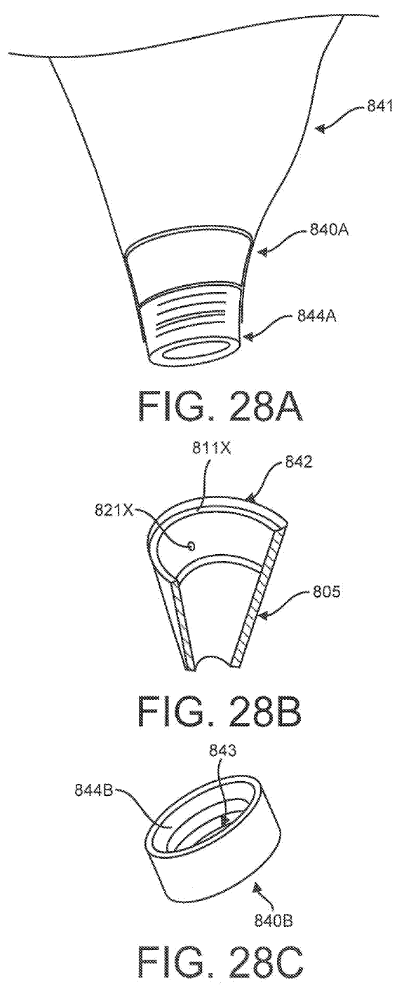

Referring to 28A, B and C, the nozzle 805 of the invention can be used with a conventional coupler 840A inserted in the pastry bag 841 and a mating collar 840B. The nozzle 805 has a flange 842 which is engaged by the mating flange 843 of the collar 840B to hold the nozzle 805 in sealing engagement against the coupler 840A when the coupler 840A and collar 840B are mated together through the threaded engagement of threads 844A and 844B. The nozzle 805 shown in FIG. 28B includes an undercut 821X in internal wall 811 X similar to the undercut 821 in internal wall 811 of nozzle 801 of FIG. 23, but the nozzle 805 could alternatively employ one or more of the undercuts 822 of nozzle 802 of FIG. 24, the shelf 823A of nozzle 803 of FIG. 25 or the multiple protrusions 823B and retaining fingers 824 of nozzle 804 of FIG. 27. When using the using the nozzle 805, liquid coloring agent is loaded into the undercut 821X of the nozzle 805 and the nozzle 805 is clamped onto the pastry bag 841 through the mating interaction of the coupler 840A, flange 842 and collar 840B.

FIGS. 29A and B respectively show a conventional coupler 840A loaded within a pastry bag 841 and an interface device 951 of the invention. The interface device 951 has internal threads 844C at one end that are the same size as the threads 844B of the conventional collar 840B so that the interface device 951 can be attached to the conventional coupler 840A through the threaded engagement of threads 844A and 844C. The interface device 951 has external threads 844D at its second or distal end which are the same size as the threads 844A of a conventional coupler 840A so that a nozzle can be applied to the second or distal end of the interface device 951 using the conventional collar. The interface device 951 shown in FIG. 29B includes a shelf 823B extending from an internal surface or wall 813B analogous to the shelf 823A as shown in FIG. 25. The interface device 951 could alternatively employ an undercut in internal wall 813B similar to the undercut 821 in internal wall 811 of nozzle 801 of FIG. 23, one or more of the undercuts 822 of nozzle 802 of FIG. 24, or the multiple protrusions 823B and retaining fingers 824 of nozzle 804 of FIG. 27. When using the using the interface device 951, a solid coloring agent is loaded onto the shelf 823B of the interface device 951 and the interface device 951 is mounted onto the coupler 840A, either before or after a tip is mounted onto the interface device using a conventional collar.

FIGS. 30A and B respectively show a conventional coupler 840A loaded within a pastry bag 841 and an extension device 971 of the invention. The extension device 971 has internal threads 844E at one end that are the same size as the threads 844B of a conventional collar 840B so that the extension device 951 can be attached to a conventional coupler 840A through the threaded engagement of threads 844A and 844E. The extension device 971 shown in FIG. 30B includes a shelf 823C extending from an internal surface or wall 813C analogous to the shelf 823A as shown in FIG. 25. The extension device 971 could alternatively employ an undercut in internal wall 813C similar to the undercut 821 in internal wall 811 of nozzle 801 of FIG. 23, one or more of the undercuts 822 of nozzle 802 of FIG. 24, or the multiple protrusions 823B and retaining fingers 824 of nozzle 804 of FIG. 27. When using the using the extension device 971, a solid coloring agent is loaded onto the shelf 823C of the extension device 971 and the extension device 971 is mounted onto the coupler 840A.

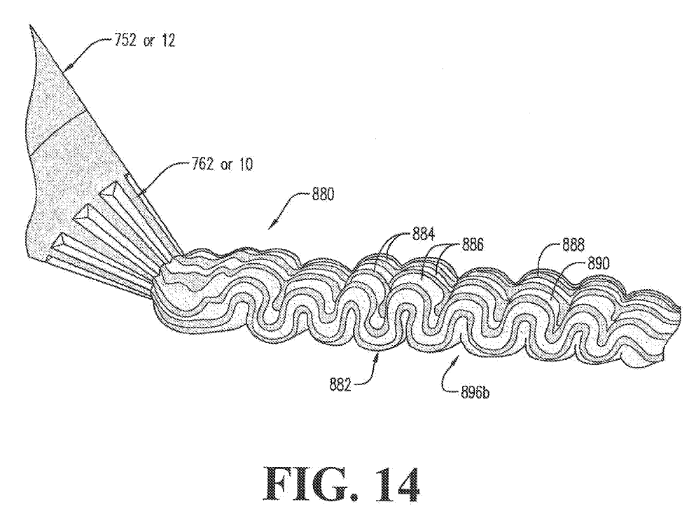

Referring to FIG. 14, food material 880 with a three dimensional ribbon candy appearance is shown being produced with the apparatus of this invention. The food material 880 has channels 882 having peaks 884 and valleys 886, with a different color 888 on each of the channel peaks 884 than the color 890 in each of the channel valleys 886. The alternating stripes of color 888 and 890 on the peaks 884 and in the valleys 886 are produced by: (a) exposing the food material 880 to coloring agents that were either: (i) applied to the internal wall of the nozzle 762 during the manufacture of the nozzle (as seen in FIGS. 11, 12 and 13); or (ii) inserted into and applied to the internal wall of the nozzle 762 just prior to insertion of the food material into the bag (as seen in FIGS. 23-27); and then by (b) “treating” the food material 880 as it is expelled from the bag 752 through the orifice 762 by the protrusions, serrations or ridges 34 in the orifice.

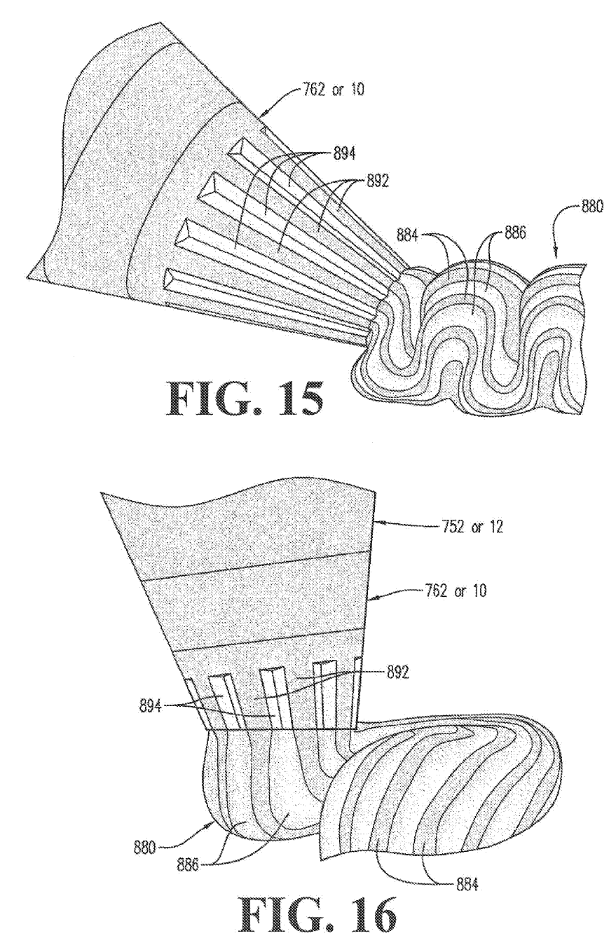

More specifically, and as best seen in FIG. 15, the food material 880 has the channel peaks 884 and the channel valleys 886 cut into it by the protrusions, serrations or ridges 34 as the food material passes through the orifice 762. First portions 892 of food material that were in contact with the coloring agents on the inside of the orifice 762 pass through the orifice 762 unobstructed and are expelled out on the peak 884 of each channel 882 with the effects of the coloring agents displayed. On the other hand, the longitudinally extending protrusions, serrations or ridges 34 in the orifice 762 cut into the food material 880 and expose second portions 894 of the food material that were not in contact with the coloring agents on the inside of the orifice 762, which second portions 894 are expelled out in the valley 886 of each channel 882 without any effect of the coloring agents being displayed. The “treatment” of the food material which occurs within the apparatus of this invention is unique and not possible to replicate with prior art DDB apparatus.

FIGS. 15 and 16 are close-up perspective views of the apparatus of this invention showing the “treatment” of the food material within the orifice that yields the unique three dimensional ribbon candy appearance in the expelled food material. The size of the opening cut into the orifice 762 of FIG. 15 is small whereas that size of the opening cut into the orifice 762 of FIG. 16 is much larger. Nevertheless, the unique construction of the orifice 762 of this invention in both cases achieves the “treatment” of the food material within the orifice that yields the unique three dimensional ribbon candy appearance in the expelled food material.

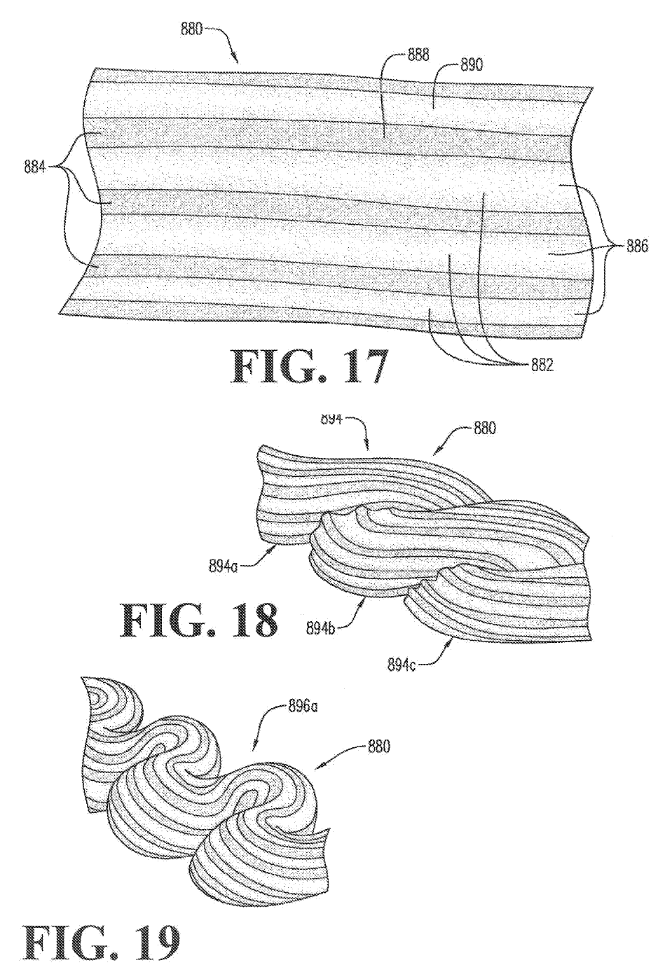

FIG. 17 is a top plan view of a straight line of food material 880 expelled from the apparatus of this invention with a three dimensional ribbon candy appearance. The channels 882 with peaks 884 and valleys 886 can be seen with alternating colors 888 and 890. This figure most clearly shows the unique “treatment” of food material that is only possible with the apparatus of this invention and is much sought after in connection with decorating applications.

FIGS. 18 through 22 show various unique decorating designs that can be produced when food material 880 is “treated” with the apparatus of this invention to yield a three dimensional ribbon candy appearance that is not possible with prior art DDB apparatus.

FIG. 18 shows a stream of food material produced with the apparatus of this invention with a three dimensional ribbon candy appearance and, through the manipulation of the apparatus during expulsion, a “braid” design 894. A first “piece” of material 894a is expelled while moving the outlet of the orifice from one side to the other and then back to and ending in the “center”—all the while making an “S” shape curve design. Then a second “piece” of material 894b is expelled with the same shape as the first, starting as if coming out of the side of the first, crossing over the “end” of the first and ending in the center in spaced relationship from the end of the first. Thereafter successive “pieces” of material 894c (etc.) are similarly produced to create a “braid” design.

FIG. 19 shows a stream of food material produced with the apparatus of this invention with a three dimensional ribbon candy appearance and, through the manipulation of the apparatus during expulsion, a horizontally undulating “scallop” design 896a (FIG. 14 shows a vertically undulating “scallop” design 896b).

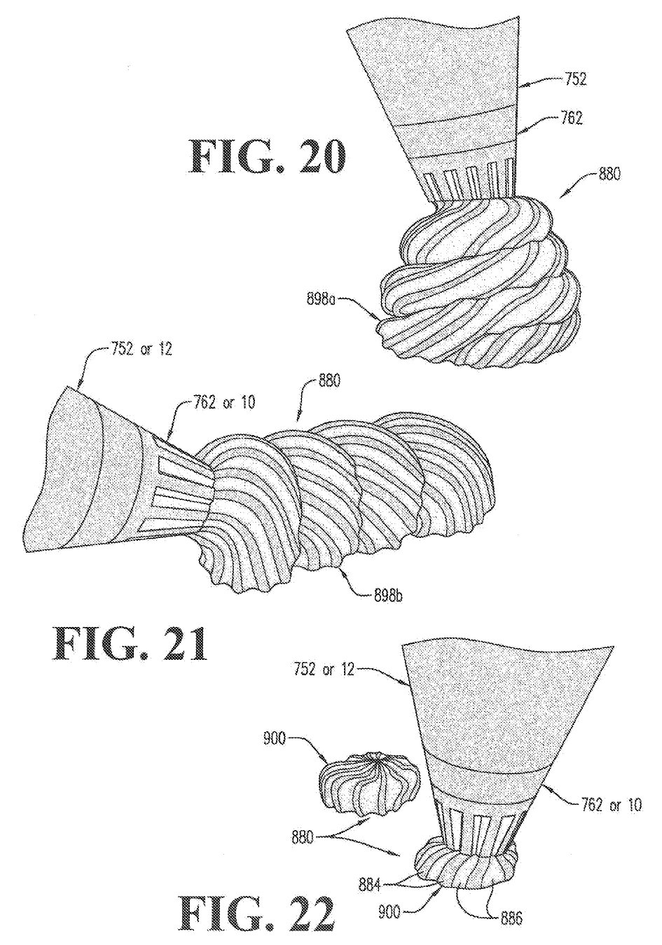

FIG. 20 shows a stream of food material produced with the apparatus of this invention with a three dimensional ribbon candy design and, through the manipulation of the apparatus during expulsion, having a vertically stacked “swirl” design 898a.

FIG. 21 shows a stream of food material produced with the apparatus of this invention with a three dimensional ribbon candy design and, through the manipulation of the apparatus during expulsion, having a horizontally drawn out “swirl” design 898b.

FIG. 22 shows a stream of food material produced with the apparatus of this invention with a three dimensional ribbon candy design and, through the manipulation of the apparatus during expulsion, having a “star” design 900.

As is readily apparent to anyone skilled in the art of decorating, many multi-colored output designs, including with or without a ribbon candy appearance as described herein, that were heretofore not readily and conveniently possible with prior art DDB devices are now possible through the novel design of the apparatus of this invention. Although some embodiments have been described with respect to a plastic, disposable nozzle, note that any embodiments might instead be associated with other types of nozzles (e.g., a non-disposable metal nozzle or top). While the preferred embodiments of the invention have been shown and described, it will be apparent to those skilled in the art that changes and modifications may be made therein without departing from the spirit of the invention, the scope of which is defined by the appended claims.

We claim:

1. A device for use with a pastry bag into which frosting is loaded for application onto food items, wherein coloring is applied to the frosting as the frosting is extruded: (i) from the pastry bag; (ii) through said device; and (iii) onto the food items; comprising:
a nozzle having:
(a) a first end attached to the pastry bag;
(b) a second, distal end having treatment means for manipulating the output size and shape of the frosting as it is extruded onto the food items;
(c) an internal wall disposed between said first and second ends; and
(d) coloring means mounted on said internal wall;
wherein said coloring means applies color to the frosting as the frosting interacts with said coloring means as the frosting passes through said device.

2. The device of claim 1, wherein said coloring means comprises:
(a) at least one coloring material reservoir affixed on said internal wall; and
(b) means for opening said reservoir to expose said coloring material;
wherein said opening means can be affected to expose said coloring material prior to extrusion of the frosting through said device to allow said coloring material to apply color to the frosting as the frosting interacts with said coloring material as the frosting passes through said device.

3. The device of claim 1, wherein said coloring means comprises:
(a) at least one coloring material deposit mounted on said internal wall; and
(b) a removable cover applied over said deposit;
wherein said cover can be removed and discarded to expose said coloring material prior to extrusion of the frosting through said device to allow said coloring material to apply color to the frosting as the frosting interacts with said coloring material as the frosting passes through said device.

4. The device of claim 1, wherein said coloring means comprises:
(a) at least one undercut in said internal wall; and
(b) at least one coloring reservoir area defined by said undercut;
wherein a viscous coloring material can be deposited in said coloring reservoir area prior to extrusion of the frosting through said device, which viscous coloring material will apply color to the frosting as the frosting interacts with the viscous coloring material as the frosting passes through said device.

5. The device of claim 4, wherein the viscosity of the coloring material is greater than the viscosity of the frosting.

6. The device of claim 1, wherein said coloring means comprises:
(a) a shelf extending from said internal wall; and
(b) a coloring material seat defined by said shelf;
wherein a solid coloring material can be seated on said seat prior to extrusion of the frosting through said device, which solid coloring material will apply color to the frosting as the frosting interacts with the solid coloring material as the frosting passes through said device.

7. The device of claim 6 wherein said shelf is an annular shaped protrusion extending around the circumference of said internal wall, said seat defined by said shelf is an annular shaped seat and the solid coloring material is an annular ring which is designed to sit on said annular seat.

8. The device of claim 6 wherein said shelf is at least one protrusion extending from said internal wall and the solid coloring material is a solid coloring chip designed to sit on said protrusion.

9. The device of claim 8 wherein said device further includes retaining means for holding the solid coloring chip on said protrusion.

10. The device of claim 9 wherein said retaining means comprises at least one finger which overlays the solid coloring chip and prevents the solid coloring chip from being forced off of said protrusion by the movement of the frosting through said device.

11. A method of applying coloring to frosting which has been loaded into a pastry bag for application onto food items, comprising the steps of:
(a) filling the pastry bag with frosting;
(b) applying coloring means to an internal wall of a nozzle;
(c) attaching the nozzle to the pastry bag; and
(d) extruding the frosting out of the pastry bag, through the nozzle and onto the food items;
wherein the coloring means applies color to the frosting as the frosting interacts with the coloring means as the frosting passes through the device.

12. The method of claim 11 wherein said step (b) further comprises depositing a viscous coloring material in a reservoir area defined by an undercut in said internal wall.

13. The method of claim 11 wherein said step (b) further comprises seating a solid coloring material on a shelf defined by a protrusion extending from the internal wall.

14. An interface device for use with a pastry bag into which frosting is loaded for application onto food items, with a conventional two-piece pastry bag coupler and collar and with a treatment nozzle, wherein said interface device is interposed between the coupler and collar, and wherein coloring is applied to the frosting as the frosting is extruded: (i) from the bag; (ii) through the coupler and said interposed interface device; (iii) through the treatment nozzle; and (iv) onto the food items; comprising:
a body having:
(a) a first end;
(b) a second, distal end;
(c) an internal wall disposed between said first and second ends;
(d) coloring means mounted on said internal wall;
(e) first means at said first end for attaching said first end of said body to the coupler; and
(f) second means at said second end for attaching said second end of said body to the treatment nozzle and collar.

15. The interface device of claim 14, wherein said coloring means comprises:
(a) at least one undercut in said internal wall; and
(b) at least one coloring reservoir area defined by said undercut;
wherein a viscous coloring material can be deposited in said coloring reservoir area prior to extrusion of the frosting through said interface device, which viscous coloring material will apply color to the frosting as the frosting interacts with the viscous coloring material as the frosting passes through said interface device.

16. The interface device of claim 14, wherein said coloring means comprises:
(a) a shelf extending from said internal wall; and
(b) a coloring material seat defined by said shelf;
wherein a solid coloring material can be seated on said seat prior to extrusion of the frosting through said interface device, which solid coloring material will apply color to the frosting as the frosting interacts with the solid coloring material as the frosting passes through said interface device.

17. An extension device for use with a pastry bag into which frosting is loaded for application onto food items and with a coupler of a conventional two-piece pastry bag coupler and collar, wherein coloring is applied to the frosting as the frosting is extruded: (i) from the bag; (ii) through the coupler; (iii) through said extension device; and (iv) onto the food items; comprising:
a body having:
(a) a first end;
(b) a second, distal end;
(c) an internal wall disposed between said first and second ends;
(d) coloring means mounted on said internal wall;
(e) first means at said first end for attaching said first end to the coupler; and
(a) second means at said second end for treating the frosting as it is dispensed therethrough.

18. The extension device of claim 17, wherein said coloring means comprises:
(a) at least one undercut in said internal wall; and
(b) at least one coloring reservoir area defined by said undercut;
wherein a viscous coloring material can be deposited in said coloring reservoir area prior to extrusion of the frosting through said extension device, which viscous coloring material will apply color to the frosting as the frosting interacts with the viscous coloring material as the frosting passes through said extension device.

19. The extension device of claim 17, wherein said coloring means comprises:
(a) a shelf extending from said internal wall; and
(b) a coloring material seat defined by said shelf;
wherein a solid coloring material can be seated on said seat prior to extrusion of the frosting through said extension device, which solid coloring material will apply color to the frosting as the frosting interacts with the solid coloring material as the frosting passes through said extension device.

20. The extension device of claim 19 wherein said shelf is at least one protrusion extending from said internal wall and the solid coloring material is a chip designed to sit on said protrusion, and the extension device further includes retaining means for holding the solid coloring chip on said one protrusion.
